(19) United States
(12) Patent Application Publication
(10) Pub. No.: US 2017/0108009 A1
(43) Pub. Date: Apr. 20, 2017

(54) ASSEMBLY FOR THE ROTATABLY FIXED CONNECTION OF AT LEAST TWO ROTATING PARTS IN A GAS TURBINE AND BALANCING METHOD

(71) Applicant: Rolls-Royce Deutschland Ltd & Co KG, Blankenfelde-Mahlow (DE)

(72) Inventor: Falko OBEREICH, Ruhland GT Arnsdorf (DE)

(21) Appl. No.: 15/291,567

(22) Filed: Oct. 12, 2016

(30) Foreign Application Priority Data
Oct. 14, 2015 (DE) 10 2015 219 954.1

(51) Int. Cl. F04D 29/66; F01D 25/04; F04D 29/053; G01M 1/32

(52) U.S. Cl. CPC F04D 29/662; G01M 1/32; F01D 25/04; F04D 29/053; F05D 2220/32; F05D 2230/60; F05D 2240/60

(57) ABSTRACT

An assembly for the non-rotatable connection of at least two rotating components in a gas turbine is provided. The assembly includes at least the following:
one holding element for at least two connecting elements, where the holding element
has for each of the connecting elements an aperture, into which a section of a connecting element can be inserted, and
   between two openings forms a section, which when the connecting elements are inserted into the apertures prevents them from rotating in the aperture,
and
at least one fastening element to hold the holding element on one of the components and/or to connect the holding element with at least two components of the assembly, before the at least two rotating components are non-rotatably connected to one another using the connecting elements.

The fastening element is additionally equipped and intended to fix at least one balancing element on the holding element.

### REFERENCE TO RELATED APPLICATION

This application claims priority to German Patent Application No. 10 2015 219 954.1 filed on Oct. 14, 2015, the entirety of which is incorporated by reference herein.

### BACKGROUND

This invention relates to an assembly, in particular for the non-rotatable connection of at least two components in a gas turbine and to a method for balancing an arrangement having at least one assembly of this type.

Inside a gas turbine, different components have to be non-rotatably connected to one another. This applies to both static components, i.e. those not moving during gas turbine operation, and to rotating components in the area of a compressor or turbine stage. For non-rotatable connection to one another, the individual gas-turbine components usually have flanges with several apertures or holes through which connecting elements needed for non-rotatable connection, for example threaded bolts, are inserted and bolted. Several connecting elements arranged along a circumference of a gas-turbine component are generally used for non-rotatable connection of gas-turbine components. These connecting elements can, to simplify fitting, be held in a rotation-preventing manner on one of the components when the non-rotatable connection to the at least one other component is made. In this connection, it is known for example from EP 1 091 089 B1, U.S. Pat. No. 5,052,891A and US 2013/0011253 A1 to provide a rotation preventer on a separate holding element for two connecting elements. Using this holding element, the bolts are then, for example when they are intended as connecting elements, secured at their bolt heads against rotation when a nut is being screwed onto them.

With the solution known from US 2013/0011253 A1 for connecting two stationary gas-turbine components in the area of a casing, a fastening element in the form of a protruding pin is additionally provided on a holding element. This can be used for pre-positioning the holding element on one of the components to be connected. The pin provided on the holding element is here simply inserted into a corresponding aperture on an edge-side flange of the component. With an appropriate length of this pin, it can also pass through aligned apertures on the several components to be connected, in order to pre-position the holding element.

It is also known from practice to use holding elements, on which the connecting elements for the connection of two gas-turbine components are held in a rotation-preventing manner, for the additional attachment of balancing weights when the components to be connected to one another are components that rotate during operation of the gas turbine. To do so, a section is then as a rule provided on a holding element, at which weights necessary for balancing can be clamped or bolted on. To meet the requirements for the lowest possible imbalance in components that rotate inside a gas turbine, at least a dozen fastening points are often defined here along a circular line about a rotational axis of the gas-turbine components, to each of which points a balancing weight can be attached.

In EP 1 380 722 B1, it is proposed that so-called anti-score plates of differing shapes and masses be provided on rotating gas-turbine components for balancing. These anti-score plates are used to prevent a bolt or a screw used for non-rotatable connection from directly contacting with its bolt or screw head a flange surface on one of the components during fitting, and the bolt head damaging the flange surface during fitting. The anti-score plates in EP 1 380 722 B1 usable as holding elements are usually combined with rotation preventers to be attached separately, to keep the bolt heads in position during fitting.

### SUMMARY

Based on the previously stated state of the art, the task underlying the present invention is to improve the non-rotatable connection of two gas-turbine components using several (at least two) connecting elements, for example threaded bolts or screws, to simplify the fitting process, and also to facilitate balancing for rotating gas-turbine components.

This task is achieved both with an assembly as described herein and with a balancing method as described herein.

In accordance with the invention, an assembly is proposed for non-rotatable connection of at least two rotating components in a gas turbine, with this assembly including at least one holding element, at least two connecting elements and at least one fastening element. The at least two, typically longitudinally extending connecting elements, for example in the form of (threaded) bolts, threaded rods or screws, are intended for non-rotatable connection of the two components to one another. The holding element has for each of the connecting elements an aperture into which a section of a connecting element can be inserted along an insertion axis. Between two apertures, the holding element forms a preferably web-like section which, when the connecting elements are inserted into the apertures, prevents them from rotating about the insertion axis inside the aperture. The holding element is held using the fastening element for example on at least one of the components before they are non-rotatably connected to one another using the connecting elements. In addition, the fastening element is in the present invention equipped and intended to fix at least one balancing element on the holding element in order to compensate for an imbalance of the rotating components in the area of their connection. The at least one fastening element thus performs a dual function: on the one hand this allows the holding element to be pre-positioned as stipulated, and on the other hand the fastening element is used for fixing at least one balancing element (balancing weight), with which a detected imbalance can be compensated for. A fastening aperture for the fastening element is provided here on the holding element, approximately in the middle between two pairs of apertures for the connecting elements.

The approximately central arrangement of the fastening element, on which an (additional) balancing element can be fixed, and the symmetrical design of a holding element that this preferably entails—relative to an axis passing through the fastening element and radially to a rotational axis of the components connected to one another permits a change of the balancing weight in the area of the center of mass of the holding element. In other words, the center of mass remains substantially unchanged, even if the holding element is combined with one or several additional balancing elements. The fastening element thus provides preferably an attachment point for at least one additional balancing element in the area of the center of mass of the holding element. The center of mass of the balancing element in the installed state here runs for example approximately on a radial axis passing through the center of mass of the holding element and through the rotational axis of the components connected to one another. Since this means that it is not necessary to take into account a change in the center of mass relative to the changed balancing mass in the event of an increase of a balancing weight on the holding element, a balancing method can be more easily automated.

The fastening element is preferably designed as a separate component that passes through a holding aperture of the holding element. The fastening element can thus for example be a threaded bolt or a screw. In one design variant, a nut is then screwed onto this bolt or screw to fix the holding element on at least one of the components before the non-rotatable connection is made using the additional connecting elements. One balancing element or several balancing elements can here be held on the holding element for example by a (bolt or screw) head of the respective fastening element. Alternatively or additionally, a balancing element can be held on the holding element by a nut connected to the fastening element, for example when the fastening element in the form of a bolt or screw is positioned such that the bolt or screw head faces in the direction of a compressor shaft.

Accordingly, it is also preferred that a balancing element fixed on the fastening element is positively fixed on the holding element by the fastening element. The positive connection then also ensures that the respective balancing element is, particularly in the case of very fast-rotating gas-turbine components, securely held on the holding element and hence on the gas-turbine components.

The section formed by the holding element for preventing rotation of the connecting elements is for example designed web-like. For example, a web-like section of this type extends radially relative to a rotational axis of the two gas-turbine components non-rotatably connected to one another if the assembly has been fitted as stipulated. Two connecting elements can thus be axially inserted through the corresponding apertures on the holding element. Any rotation of the connecting elements inserted into the aperture is however then prevented by the web-like section located between the apertures.

To improve a contact of the connecting elements, particularly in the case of annular flanges of two components that rotate during operation of the gas turbine, for example in the area of bolt heads, at a section of the holding element intended as a rotation preventer, this section is designed wedge-shaped in one design variant. The section widens here in a radially outward direction in order to provide a larger contact surface for two bolt or screw heads adjoining on opposite sides of this wedge-shaped section.

To provide a larger contact surface for a head of a connecting element on the holding element in the connection or insertion direction, in one exemplary embodiment a longitudinally extending indentation is provided at the root of a web-like section on the base of the holding element where the connecting elements are in contact and where the web-like section protrudes. A contact surface for a head of the connecting element is enlarged by this indentation without having to enlarge the holding element or the head of the connecting element itself to do so. The longitudinally extending indentation at the root of the web-like section is used here in the manner of an undercut for putting the head of the connecting element above the indentation into contact with the web-like section in a defined manner or at least to position it adjacent thereto.

Although the provision of a longitudinally extending indentation at the root of the web-like section acting as a rotation preventer is particularly advantageous for the non-rotatable connection of two components that rotate during operation of the gas turbine, a connection optimized in this way is however also advantageous in static components to be non-rotatably connected to one another. This aspect is thus not restricted to rotating gas-turbine components, and in particular not to screw or bolt connections used in this area for rotating components of a compressor or turbine stage of the gas turbine.

An assembly designed in accordance with the invention is used preferably in an arrangement in which the at least two gas-turbine components are non-rotatably connected to one another by an assembly designed in accordance with the invention or by several assemblies of this type.

For example, at least two assemblies designed in accordance with the invention and each with holding element, at least two connecting elements and a fastening element, are arranged at a distance from one another along a circular line about a rotational axis of two rotating gas-turbine components, in order to connect the at least two gas-turbine components non-rotatably to one another. The possibility of using the fastening element to fix additional balancing elements for balancing has shown that with appropriate dimensioning of the holding element and of the balancing elements less than a dozen and preferably less than nine connection points are sufficient for connecting the at least two gas-turbine components non-rotatably to one another by means of assemblies designed in accordance with the invention and for providing sufficient possibilities for balancing. At each of the connection points, a holding element with at least two or four connecting elements for example is then provided. In one design variant, six connection points are provided equidistantly distributed for example along a circular line on an annular flange of a rotor component.

To reduce the effort for balancing and also the number of components needed for balancing, it is provided in one development that one holding element is itself used for at least two connecting elements as a balancing element, and not only the balancing element or balancing weight (additionally) fixed thereon using the fastening element. In this way, at least two assemblies with differing-weight holding elements can be provided along a circular line about a rotational axis of the gas-turbine components and at a distance from one another, to compensate in this way for a detected imbalance in the connection area of the at least two gas-turbine components. In this way, for example, differing-weight holding elements can be provided for assemblies designed in accordance with the invention and can be used as required, i.e. to compensate for a corresponding imbalance and to hold the connecting elements.

In one exemplary embodiment, differing-weight holding elements with identical length are provided. A “length” of the holding element is here usually understood as the circumferential length along a circumferential direction about the rotational axis. A heavier of the at least two holding elements then however has in at least one section a greater thickness and/or width if it is made from the same material. The differing-weight holding elements can therefore, for example relative to a rotational axis of the at least two components of the arrangement to be non-rotatably connected to one another, be of the same width in the radial direction and of the same length in the circumferential direction, but are of varying thickness in the area of at least one section. The lengths of the differing-weight holding elements in the circumferential direction are preferably always the same to ensure interchangeability. Whether the width or the thickness or both of these quantities can be selected different in the case of differing-weight holding elements usually depends on external boundary conditions (e.g. installation space, constant clamping length of connecting elements, etc.).

By the use of a holding element itself as a possible balancing weight and the possibility of fixing at least one additional balancing element and hence balancing weight to it using the fastening element provided anyway, an improved balancing method is proposed in accordance with a further aspect of the invention.

Initially, at least two differing-weight first and second holding elements each with at least one fastening element and at least one balancing element that can be fixed using a fastening element on a first or second holding element are provided here. According to a first variant, the at least two gas-turbine components rotating during operation of the gas turbine are non-rotatably connected to one another, such that they jointly rotate about the same rotational axis. The connecting elements needed for non-rotatable connection are here passed through identically designed and identical-weight first holding elements. These holding elements are preferably fixed before connection to one of the gas-turbine components. If necessary, the corresponding connecting elements are already inserted at a holding element and pre-positioned on it before the respective holding element is fixed on the gas-turbine component. Then an imbalance in the connection area of the at least two gas-turbine components is measured for example by means of a balancing device in the form of a balancing machine. If an imbalance is detected, at least one of the first holding elements is replaced by a second holding element with another weight and/or at least one balancing element is attached to one of the holding elements to compensate for the imbalance. In the final analysis, several balancing elements can also be provided and are fixable on a first or second holding element using a fastening element.

According to a second variant, a balancing device is used for balancing which simulates at least one of the gas-turbine components rotating during operation and then non-rotatably connected to one another by a customized and if necessary multi-part fixture component, a so-called dummy. For example, at least one of the gas-turbine components is a component of a high-pressure turbine of a gas-turbine engine and the at least one other gas-turbine component is a component of a compressor of the gas-turbine engine, e.g. a compressor shaft. Using the balancing device, usually in the form of a so-called “balancing machine”, the high-pressure turbine or the compressor for example is then simulated and an interface is created for non-rotatable connection to the gas-turbine component to be balanced or to several gas-turbine components to be balanced and already fixed to one another, for example using several fastening elements.

In a balancing method according to the present invention, in accordance with both the first and the second alternative it is, with a comparatively small number of possible connection points for holding elements (balancing positions) and a reduced number compared with previously used approaches—of one or more additional balancing weights with differing mass, nevertheless possible to achieve a very high balancing quality. In accordance with the invention, it is furthermore provided here that a set of at least two differing-weight types of balancing elements is provided, with their weights graduated in steps to one another, said elements being fixable on the holding elements using a fastening element in order to compensate for an imbalance.

In one exemplary embodiment, at least three differing-weight first, second and third holding elements each with at least one fastening element are also provided. The first holding elements have here a first (standard) weight and are intended for initial connection of the at least two components to be non-rotatably connected to one another. If an imbalance is detected, the second and third holding elements with diverging higher weights, i.e. second and third holding elements of a second and third weight stage, are available to compensate for the imbalance. Preferably, in particular in the case of major imbalances, the weight of the second and third holding elements is used here for attaching a balancing weight several times larger than for the (additional) attachment of an (additional) balancing element fixed on a fastening element of a first, second or third holding element.

To be able to increase a balancing weight in consistent steps using the second and third holding elements, a weight difference between the weights of a second and a first holding element is identical to the weight difference between the weights of a third and second holding element. The weight differences between holding elements of adjacent weight stages—relative to a pitch circle radius about a rotational axis—are thus identical and are for example 12.5 g. Here and in the following the terms “weight” and “weight difference” between the holding elements always relate to the actually acting balancing mass (i.e. the net extra weight available for correcting an imbalance).

For example, it can be provided that the total weight of an individual balancing element attachable to a holding element using a fastening element, or the total weight of several balancing elements (of differing or equal weight) attachable to a holding element using a fastening element, corresponds exactly to a minimum, i.e. lowest possible weight difference between two differing-weight holding elements (adjacent weight stages). Instead of having to replace the holding element of a first weight stage by a next-heavier holding element of an adjacent weight stage, it is thus possible in this variant to use an additional balancing element with the same net extra weight for compensation of a corresponding imbalance.

In another variant, it is provided that a weight difference that can be provided by a balancing element fixable on a holding element or several balancing elements fixable on the holding element corresponds to exactly half or a maximum of half the minimum weight difference between two differing-weight holding elements. In other words, for example several (at least two) balancing elements of identical or differing weight can be fixed on a holding element using the one fastening element, and the minimum weight difference between differing-weight holding elements is (a) just as great as or (b) greater than double the maximum total weight of all balancing elements fixable on a holding element using a fastening element as stipulated. In other words, several balancing elements are provided here and are more finely graduated than the differing-weight holding elements, in order to achieve a more accurate compensation of an imbalance by using the balancing elements that are fixable on a fastening element.

In an exemplary embodiment according to the aforementioned variant (a), for example three differing-weight types of balancing elements of 1.25 g, 2.5 g and 3.75 g are provided, of which a maximum of two balancing elements (e.g. each of 3.75 g) can be fixed on a holding element using a fastening element. The holding elements differ here in weights of 15 g (=2×(3.75 g+3.75 g)), 30 g and 45 g, so that using these, it is possible, even with a smaller number (e.g. six) of possible balancing positions defined by the connection points of the components, to provide compensating balancing masses in 1.25 g steps using only three differing-weight holding elements and only three differing-weight balancing elements (also refer to tables 3a to 3d).

Alternatively, a variant is provided for a graduation of the possible balancing masses in consistent steps, in which a single balancing element can be attached to a holding element using the fastening element, and said balancing element has a weight corresponding to exactly half the minimum weight difference between two differing-weight holding elements. There are then for example one or more differing-weight holding elements (e.g. with a net extra weight of 10 g per weight stage) and a balancing element (e.g. with a net extra weight of 5 g), where in each case only one holding element and, using the fastening element, one balancing element of the set of different balancing elements can be fixed at the connection points. Since the net extra weight between the holding elements corresponds to exactly double the weight of the balancing element that can be additionally attached if required, the balancing mass can be increased in consistent steps by the amount of the weight of the balancing element (e.g. in steps of 5 g).

In an exemplary embodiment according to the aforementioned variant (b), when several differing-weight balancing elements are used for fine balancing, the minimum weight difference between two holding elements exceeds double the maximum total weight of all balancing elements only by exactly the amount of a minimum weight difference between differing-weight balancing elements. For example, a minimum weight difference of differing-weight holding elements is then 12.5 g and a minimum weight difference between different balancing elements is 0.5 g. The maximum total weight of all balancing elements fixable using a fastening element should in this case then be 6 g (12.5 g=2×6 g+0.5 g or (12.5 g−0.5 g)/2=6 g). An additional weight difference (6 g) possible using one balancing element or several balancing elements is therefore lower here than half (6.25 g) the minimum, i.e. the lowest possible weight difference between two differing-weight holding elements (12.5 g). Or stated in other words, the minimum weight difference here between two holding elements (12.5 g) is exactly double the maximum total weight of all balancing elements (2×6 g) fixable on a holding element as stipulated, plus the amount of a minimum weight difference (0.5 g) between differing-weight balancing elements.

In another variant, it is provided that a set of balancing elements is provided with at least three different weight stages for fine balancing, where a weight difference between two types of balancing elements of directly consecutive weight stages (for example weight stage n and weight stage n−1) is identical and corresponds to a maximum of one tenth of a minimum weight difference between two differing-weight holding elements. The difference between the weight of a balancing element of a weight stage (n) and the weight of a balancing element of a next-higher stage (n+1) is thus always smaller than 1/10 of a minimum weight difference between two differing-weight holding elements. As a result, for example in a design variant based thereon, the minimum difference between two differing-weight holding elements is 12.5 g, while the largest difference between two weights of two (additional) balancing elements of consecutive weight stages is a maximum of 1 g. For example, second holding elements (holding elements of a second type) are therefore provided, which compared with the first holding elements (holding elements of a first type) have a net extra weight of 12.5 g, and third holding elements (holding elements of a third type) which compared with the second holding elements have a net extra weight of 12.5 g (and hence compared with the first holding elements an extra weight of 25 g). The weights of the additional and preferably standardized balancing elements are here graduated in 0.5 g, 1 g, 2 g, 3 g, 4 g, 5 g and 6 g. A minimum net weight difference between two differing-weight holding elements is here 12.5 g. Furthermore, the maximum net weight difference between two balancing elements of directly consecutive weight stages is 1 g here. Preferably, a maximum of 6 g of the total mass can be fixed on a fastening element using one balancing element or several balancing elements.

The measurement of an imbalance in the connection area of the at least two gas-turbine components or of an imbalance in the connection area between gas-turbine component and fixture component is for example performed by means of a balancing device displaying to a user the position, number and/or weight of balancing elements to be attached and/or the position and weight of holding elements to be attached (or to be replaced) in order to compensate for a measured imbalance. To do so, an evaluation logic unit for example is implemented in the balancing device which not only displays the total imbalance to be compensated for and its position, but also informs a user of which and of how many of the available balancing elements and holding elements have to be attached or replaced for compensation of the corresponding imbalance at which of the possible connection points. The evaluation logic unit here preferably also takes into account that only a limited number of different types and hence differing-weight balancing elements and holding elements are available. For example, the number of replaceable holding elements with different weight is limited to three, and the number of usable, standardized (additional) balancing elements with different weights is less than eight, preferably seven. The evaluation logic unit thus takes into account for example that the balancing or correction mass of 12 g required to compensate for an imbalance can be achieved by a different holding element with a net extra weight or “net balancing weight” of 12.5 g at the opposite position and by an additional balancing element of 0.5 g in the area of the detected imbalance to compensate for the measured imbalance.

Alternatively, it can of course be provided that the balancing device displays to a user only the position-related imbalance, and the user then determines himself, on the basis of the available connection points and the available weights of the different holding elements and (additional) balancing elements—for example with the aid of an appropriate table—the necessary elements and positions to compensate for the measured imbalance.

The invention is obviously advantageously usable for different types of gas turbines. A possible variant is in particular its implementation in a gas-turbine engine.

### BRIEF DESCRIPTION OF THE DRAWINGS

Further advantages and features of the present invention become apparent from the following description of exemplary embodiments shown in the figures.

FIG. 1 shows in perspective view an exemplary embodiment of an assembly in accordance with the present invention for non-rotatably connecting a rotating component of a high-pressure turbine in a gas-turbine engine to a holding plate used as a holding element and four threaded bolts held thereon.

FIG. 2 shows in sections and in a sectional view the connection of three components in the high-pressure turbine provided by a threaded bolt of the assembly in FIG. 1.

FIGS. 3A-3B show different views of the holding plate of the assembly in FIG. 1.

FIGS. 4A-4B show different views of a second, heavier holding plate.

FIGS. 5A-5B show different views of a third, even heavier holding plate.

FIG. 6 shows an assembly of FIG. 1 in the assembled state as stipulated with an additional balancing element fitted to the holding plate.

FIG. 7 shows in a view matching FIG. 1 an assembly designed in accordance with the present invention with the second holding plate according to FIGS. 4A and 4B and an additional balancing element fixed thereon.

FIG. 8A shows a front view of a circular flange of a wheel disk for the high-pressure turbine with assemblies arranged thereon as stipulated, each having a holding plate and four threaded bolts for non-rotatable connection to a further rotating turbine component.

FIG. 8B shows a sectional view along the sectional line CA-CA entered into FIG. 8A for illustration of the fastening elements for positively connecting a holding element and a balancing element on at least one gas-turbine component.

FIG. 8C shows a rear view along the turbine or rotational axis facing towards the annular flange of the wheel disk of the high-pressure compressor.

FIG. 8D shows a sectional view along the sectional line AC-AC entered into FIG. 8C.

FIG. 9 shows the annular flange of FIG. 8A, illustrating the six possible connection points, each one for an assembly designed in accordance with the present invention and illustrating by way of example two imbalance positions.

FIG. 10 schematically shows a flow chart for a balancing method in accordance with the present invention.

FIG. 11 shows in sections a part of a holding plate in a sectional view, with two bolt heads adjoining the latter, which are secured against rotation using a web, said web having on its root two indentations opposite to one another.

FIGS. 12A to 12D show different views of a variant of an assembly having a holding plate for two threaded bolts.

FIG. 13 shows in sections and in a sectional view a balancing device simulating a compressor shaft for balancing gas-turbine components, emphasizing two balancing planes on the high-pressure turbine rotor.

FIG. 14 shows in sections and in a sectional view a high-pressure turbine rotor of a gas-turbine engine, emphasizing two balancing planes.

### DETAILED DESCRIPTION

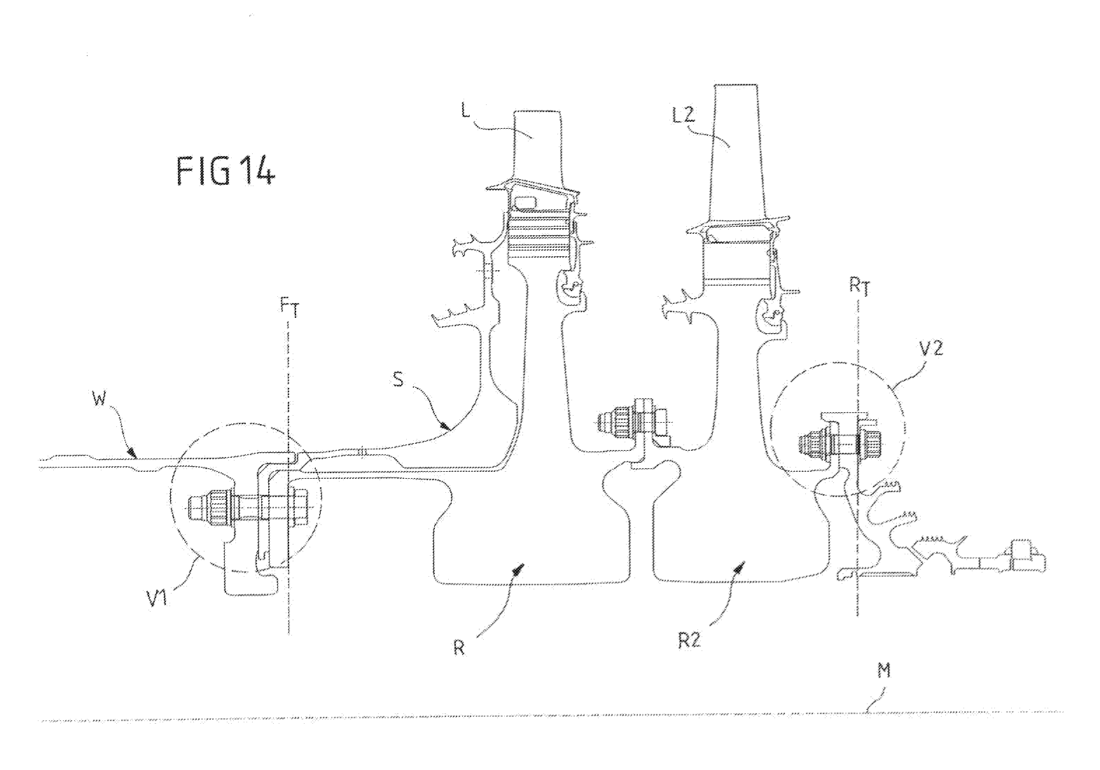

FIG. 14 shows in sections a gas-turbine engine in a sectional view in the area of the high-pressure turbine. The high-pressure turbine is here arranged along an engine axis M downstream of the high-pressure compressor. (Rotor) wheel disks R and R2 non-rotatably connected to one another here carry rotor blades L and L2 in a manner known per se. At an axially rear end the one wheel disk R2 is connected via an annular flange to an also rotating turbine component, for example a bearing shaft. The non-rotatable connection is made in a connection area V2. The further wheel disk R non-rotatably connected to the wheel disk R2 is non-rotatably connected in a connection area V1 at its axially front end to a cover disk S and a further shaft component, in this example the compressor shaft W of the gas-turbine engine. The connection in the connection areas V1 and V2 is made in each case using several threaded bolts arranged at intervals along the circumference. To prevent vibrations and oscillations in the extremely fast-rotating wheel disks R and R2 during operation of the gas-turbine engine, the connection areas V1 and V2 are thoroughly checked in the balance planes F_{T} and R_{T} for any imbalances. If imbalances are detected in these balance planes F_{T} and R_{T}, they are compensated by means of balancing elements, to achieve the most vibration-free rotation possible of the compressor and turbine shaft.

As part of the solution in accordance with the invention, a holding element for attaching several stepped bolts and securing them against rotation during fitting is proposed here, in particular to improve a balancing method, said holding element itself being additionally usable as a balancing element and to which additional balancing elements can be fixed in a simple manner and in particular without additional fastening elements.

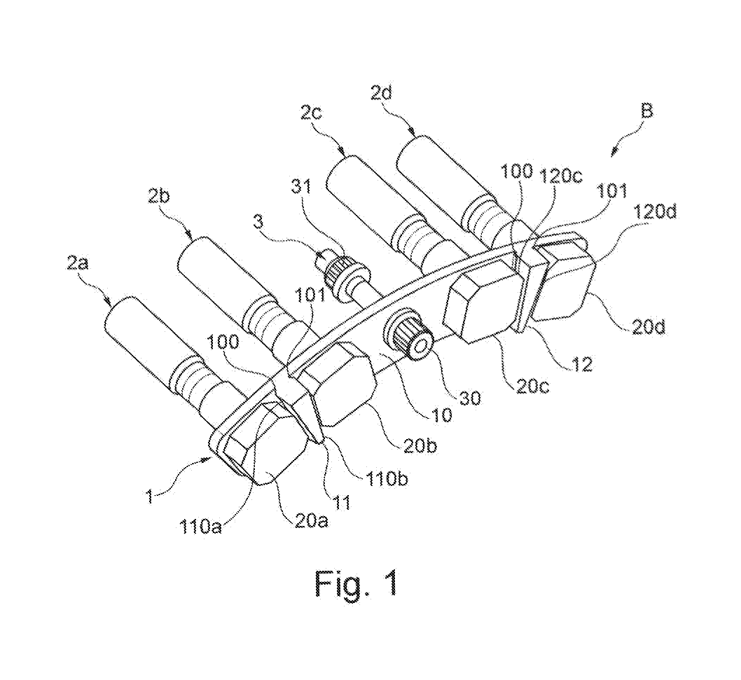

FIG. 1 thus shows as an example a fastening assembly B for the non-rotatable connection of the wheel disk R, the cover disk S and the compressor shaft W to one another. Using six of these fastening assemblies B, the three stated components R, S, W are non-rotatably connected to one another using annular-designed flanges RF, SF and WF respectively. A fastening assembly B has here a holding element in the form of a holding plate 1 defining a circular-segment-shaped base 10. At this base 10, pairs of bolt apertures 14a, 14b and 15a, 15b are provided—as can be seen when FIGS. 1, 2 and 3A-3B are viewed together. A connecting element in the form of a hammerhead bolt or threaded bolt 2a, 2b, 2c or 2d with a T-shaped head is inserted through each of these bolt apertures 14a, 14b, 15a or 15b. A bolt head 20a, 20b, 20c and 20d of a threaded bolt 2a, 2b, 2c or 2d then contacts the base 10. The threaded sections of the threaded bolts 2a, 2b, 2c and 2b are passed through corresponding apertures in the turbine components R, S and W. Screwed-on nuts 21 are then used to fix the turbine components R, S and W to one another and non-rotatably connect them to one another.

To prevent the bolts 2a to 2d from turning while the nuts 21 are being screwed on, the holding plate 1 has on its base protruding webs 11 and 12 for one pair each of threaded bolts 2a-2b and 2c-2d. The individual webs 11 and 12 here protrude upward at the base 10 and have a wedge shape. The tapering end of this wedge points here in the direction of the rotational axis about which the components R, S and W rotate during operation of the gas-turbine engine. In other words, the webs 11 and 12 widen radially outwards. The distances of a pair of apertures 14a, 14b or 15a, 15b are here matched to the bolt heads 20a, 20b and 20c, 20d respectively such that the web 11 or 12 formed between two apertures 14a, 14b or 15a, 15b prevents any rotation of the threaded bolts 2a to 2d inserted into the bolt apertures 14a, 14b and 15a, 15b.

Each web 11 or 12 has for that purpose lateral faces 110a, 110b or 120c, 120d which face an adjacent bolt head 20a, 20b or 20c, 20d respectively. These lateral faces 110a, 110b or 120c, 120d are in contact with a bolt head 20a, 20b or 20c, 20d to prevent any rotation of the respective threaded bolts 2a to 2d when inserted into the holding plate 1. A longitudinally extending indentation 100 or 101, running radially in the installed state as stipulated, is provided at the root of each web 11 or 12, on both sides in the area of the base 10, in the manner of an undercut. Using these indentations 100 and 101 on the rib-like projecting webs 11 and 12, the respective bolt heads 20a to 20d in the area of the respective web 11 or 12 can be in flat contact with the base 10 without any problem. At the same time it is ensured, without additional installation space for the holding plate 1 being required, that the bolt heads 20a to 20d are present in the area of the lateral faces 110a, 110b and 120c, 120d of the webs 11 and 12 in a defined manner to prevent the threaded bolts 2a to 2d from rotating.

To hold a holding plate 1, with or without threaded bolts 2a to 2d already fixed thereon, on the flange RF of the wheel disk R or on the flanges RF and SF of the turbine components R, S, a fastening aperture 13 is provided at the base 10 for a fastening element of the fastening assembly B in the form of a fastening bolt 3. Using this fastening bolt 3 and a nut 31 screwed onto it, the holding plate 1 can be fixed on the flange RF of the wheel disk R, and the flanges RF and SF of the wheel disk R and the cover disk S respectively can be connected to one another. In this way, it is possible using the fastening elements 3 to pre-assemble the turbine components R and S together with the holding elements 1. The subsequent bolted connection of the compressor shaft W and the turbine shaft, which also includes the wheel disks R, R2 and the cover disk S, is made using the threaded bolts 2a to 2d and the associated nuts 21.

A head 30 of the fastening bolt 3 is provided here on the same side of the base 10 as the bolt heads 20a to 20d of the threaded bolts 2a to 2d. It should however be pointed out that this is of course not mandatory and the fastening bolts 3 can for example also be installed such that the respective bolt head rests on the component S and the nut on the base 10. The fastening aperture 13 for the fastening bolt 3 is here formed approximately in the middle between the two pairs of bolt apertures 14a, 14b and 15a, 15b. The head 30 of the fastening bolt 3 thus protrudes approximately in the middle between the two pairs of bolt heads 20a/20b and 20c/20d at the base 10 if the fastening assembly B has been fitted as stipulated. In the present case, a fastening aperture 13 and the bolt apertures 14a, 14b and 15a, 15b are on a circular line about the engine axis M. This is however not mandatory. The radial positions of the fastening aperture 13 and the bolt apertures 14a, 14b and 15a, 15b can therefore also differ from one another.

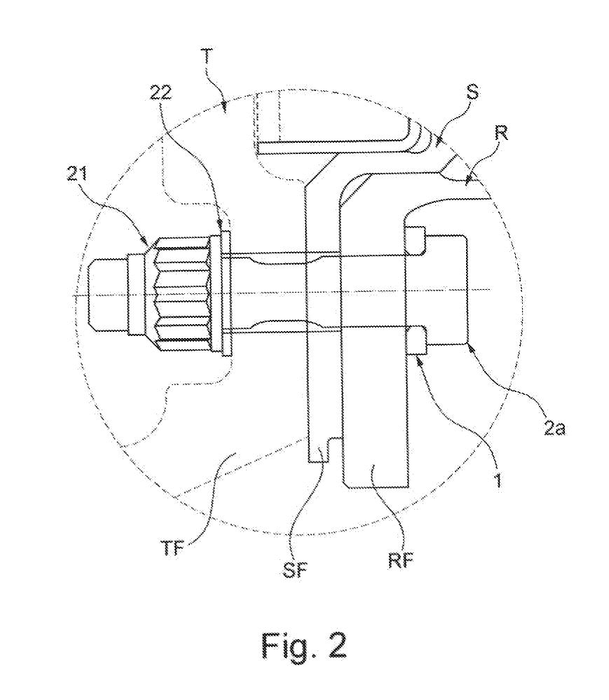

In the present case, the fastening assembly B for attachment to the flange RF of the wheel disk R is provided in the area of an end face at the rear in the axial direction. On the side at the front in the axial direction, at which the nuts 21 are screwed onto the inserted threaded bolts 2a to 2d, an anti-score plate 22 is also provided as shown in the sectional view of FIG. 2. This anti-score plate 22 prevents scoring of the surface of the flange WF of the compressor shaft W during screwing on the respective nut 21.

As part of the inventive solution, in the present invention different types of holding plates 1, 1.1 and 1.2 with different weights are provided. Furthermore, each fastening bolt 3 is not only intended to pre-assemble and pre-position a holding plate 1, 1.1 or 1.2 as stipulated, and in the present example to fix the flanges RF and SF of the components R and S to one another; instead at least one preferably sleeve-like (additional) balancing element 4 can also be fixed on every fastening bolt 3 to compensate for a possible imbalance in the balancing plane F_{T}. For balancing however, differently shaped balancing elements can also be fixed on a fastening bolt 3. The number of different shapes and weights is however standardized and hence limited in the present invention.

The approximately central arrangement of the fastening bolt 3, and the symmetrical design of the holding plates 1, 1.1 and 1.2 relative to a symmetry axis passing through the center of the respective bolt aperture 13 and running radially to the rotational axis M, permits a change of the balancing weight in the area of the center of mass of a holding plate 1, 1.1 or 1.2. In other words, the center of mass in the circumferential direction is preserved even if the respective holding plate 1, 1.1, 1.2 is replaced by another holding plate 1.1, 1.2, 1 or combined with one or more additional balancing elements 4. The fastening bolt 3 thus provides preferably an attachment point for at least one additional balancing element 4 in the area of the center of mass of each holding plate 1, 1.1, 1.2. This enables a balancing method to be more easily automated. In particular when a balancing weight is increased by replacement of a holding plate 1, 1.1, 1.2 and/or a balancing element 4 is attached on a holding plate 1, 1.1, 1.2, no (relevant) change of the center of mass (in circumferential direction) occurs that would have to be taken into account for an optimum balancing result.

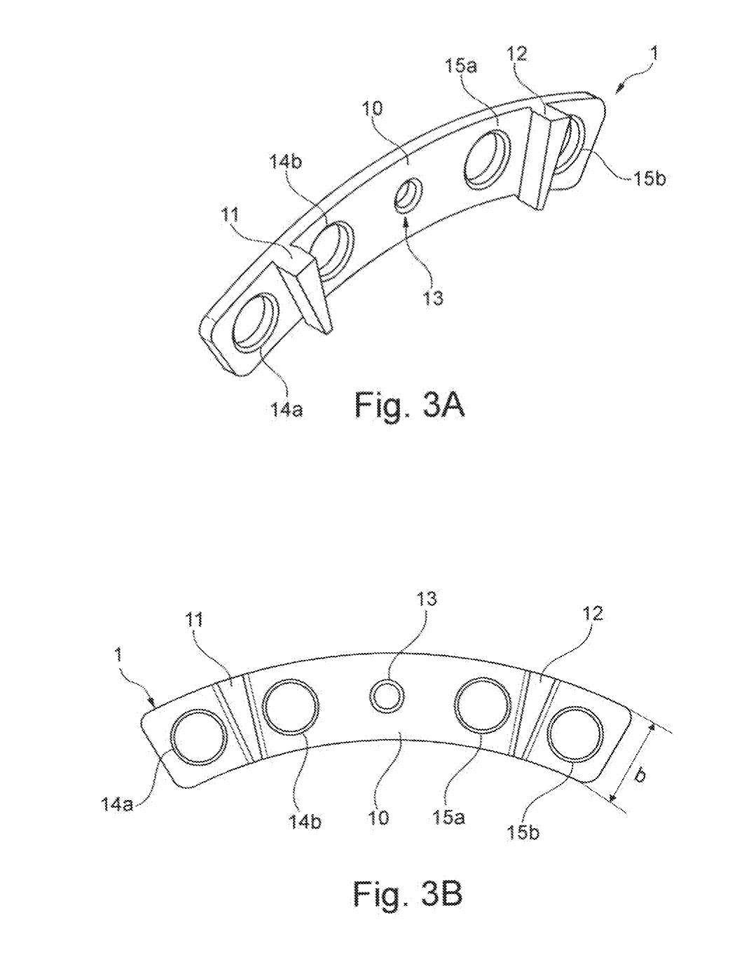

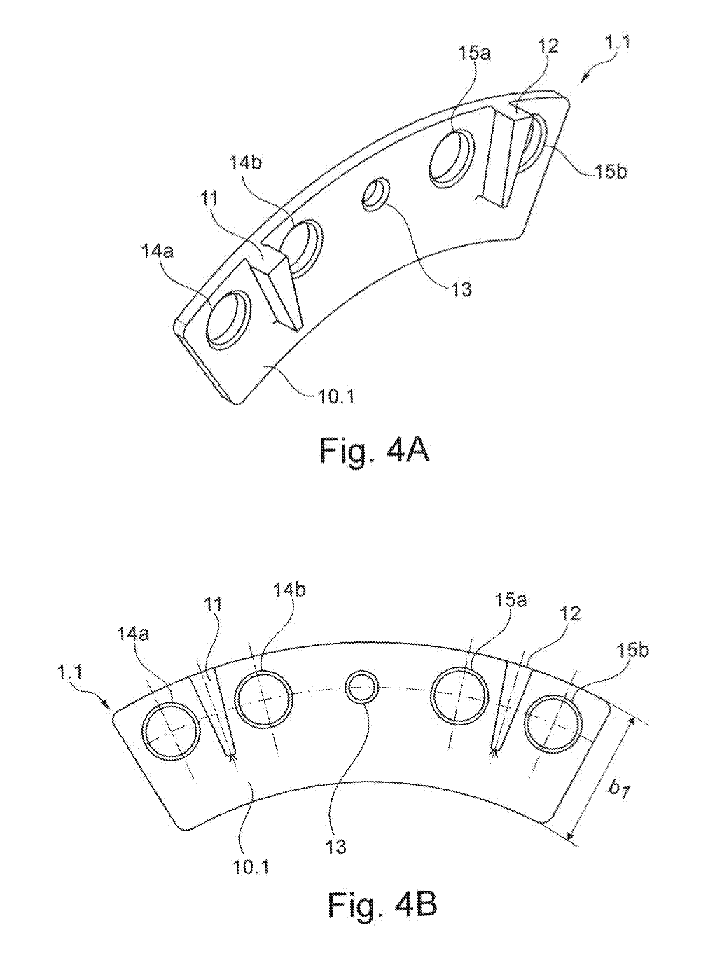

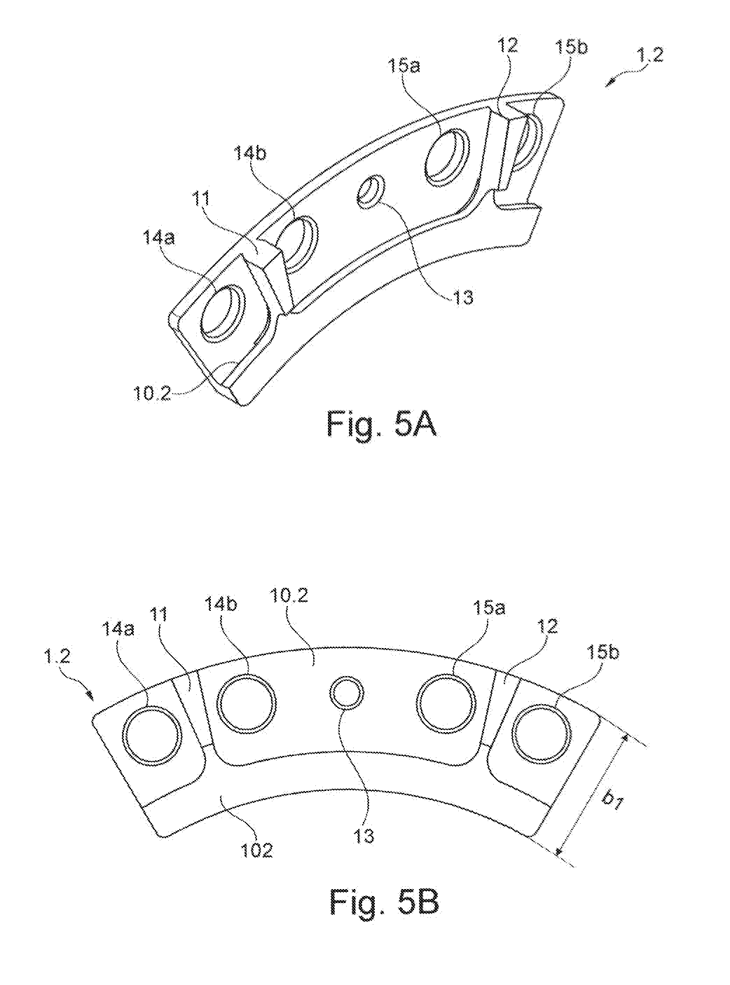

FIGS. 4A, 4B and 5A-5B show here in views matching FIGS. 3A and 3B two further types of second and third holding plates 1.1 and 1.2 designed with differing weights using differently designed bases 10.1 and 10.2. While a second holding plate 1.1 of FIGS. 4A and 4B is widened compared with a first holding plate 1 in the radial direction, and hence has a width b1 greater than a width b of the first holding plate 1 according to FIGS. 3A and 3B, a third holding plate 1.2 of FIGS. 5A and 5B is only locally thickened compared with the variant in FIGS. 4A and 4B. The holding plates 1.1 and 1.2 in FIGS. 4A-4B and 5A-5B thus have identical widths b1 and lengths (in the circumferential direction). The heavier holding plate 1.2 is however provided on a radially inner area of the base 10.2 with a thickened area 102 that protrudes upward at the base 10.2. All holding plates 1, 1.1 and 1.2 have identical circumferential lengths to ensure interchangeability of the holding plates 1, 1.1, 1.2. Also, all holding elements 1, 1.1, 1.2 have an identical thickness in the contact area of the connecting elements in the form of threaded bolts 2a to 2d, in order to avoid a change in the clamping length of the connecting elements.

The weights of the individual holding plates 1, 1.1 and 1.2 differ in each case, for example by 12.5 g. By contrast the additional balancing elements 4 intended for attachment using the fastening bolt 3 are considerably lighter and individually have a maximum weight of 6 g.

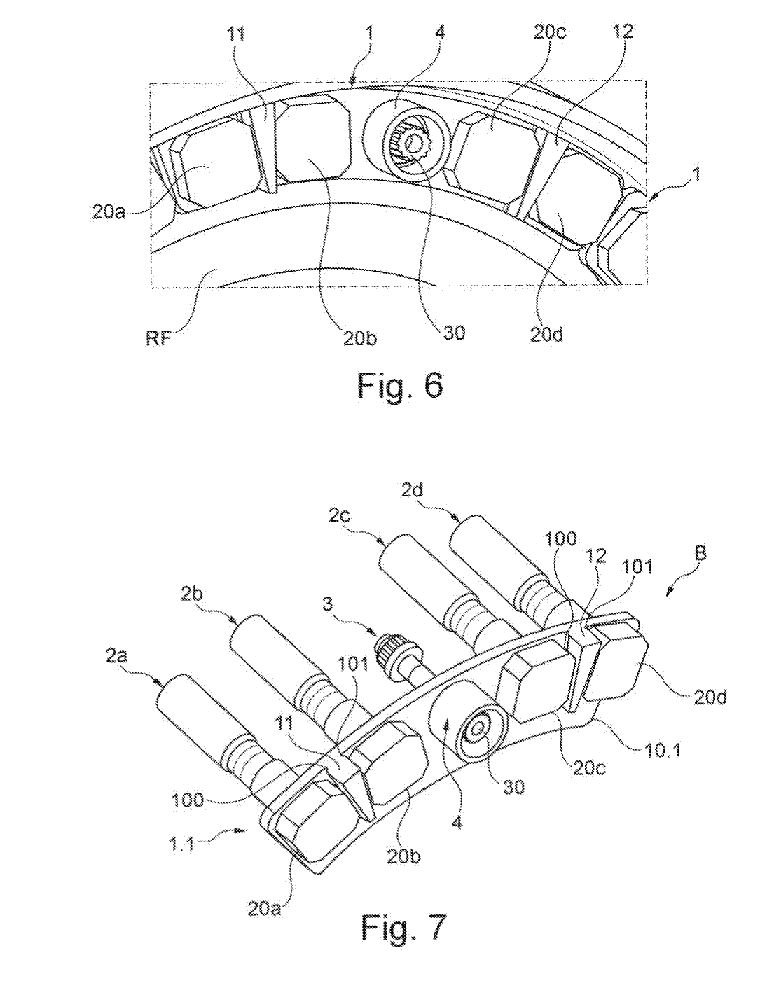

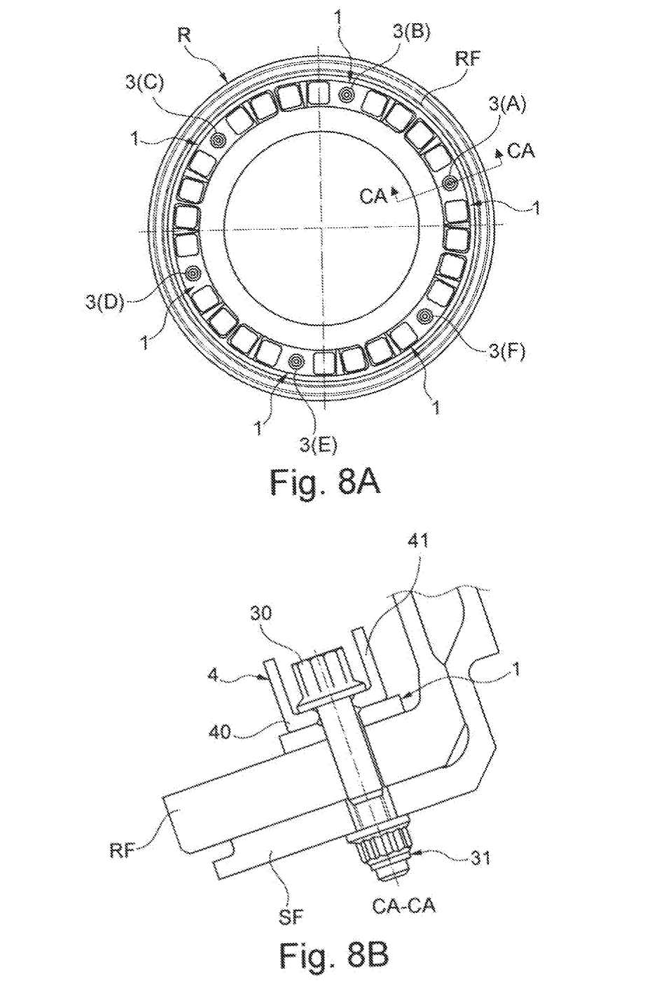

In a preferred variant, seven different balancing elements 4 are available for attachment to a fastening bolt 3. They have weights of 0.5 g, 1 g, 2 g, 3 g, 4 g, 5 g and 6 g respectively. In combination with the differing-weight holding plates 1, 1.1 and 1.2 therefore, balancing weights in steps of 0.5 g up to a total weight of 31 g can be fastened to compensate for imbalances. This graduation is not only relatively fine, but also permits, despite the small number of different additional balancing elements 4 and holding plates 1, 1.1 and 1.2 with comparatively few (in this case six) connection points for the attachment of holding plates 1, 1.1 and 1.2, effective and precise compensation even of major imbalances. A connection point on the flange RF of the wheel disk R is here designed such that the heavier holding plates 1.1 or 1.2 can also be arranged alternatively at the six connection points provided along the circumference for the arrangement of a holding plate 1. The distances of the bolt apertures 14a, 14b and 15a, 15b from one another and from a fastening aperture 13 for the fastening bolt 3 are here identical to one another for the different holding plates 1, 1.1 and 1.2, as illustrated by FIGS. 6 and 7, so that the holding plates 1, 1.1 and 1.2 can be interchanged with one another without any problem and additional balancing elements 4 (identically designed in respect of their fastening possibility, i.e. provision of a passage opening for the fastening bolt 3) can be fixed using the respective fastening bolt 3 on a holding plate 1, 1.1 or 1.2.

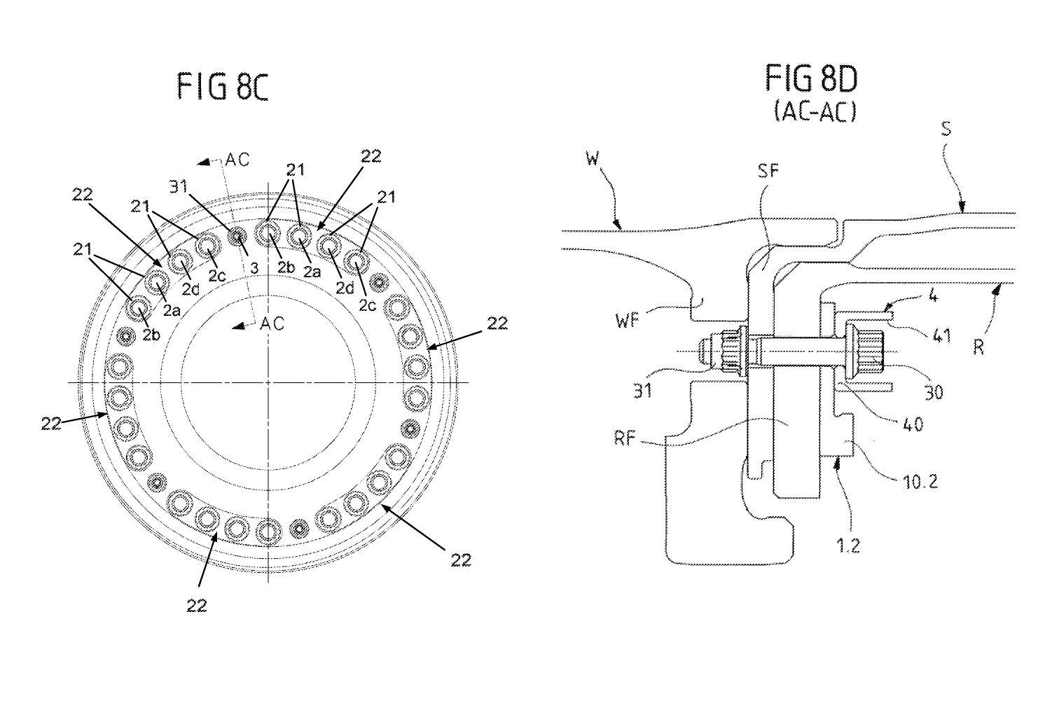

According to FIG. 8A, in the present exemplary embodiment six connection points each spaced at 60° from one another are defined on the flange RF of the wheel disk R. At each connection point a passage opening for a fastening bolt 3 is provided, for positioning a holding plate 1, 1.1 or 1.2 using this. According to the sectional view in FIG. 8B the fastening bolt 3 passes here not only through the edge flange RF of the wheel disk R, but also the flange SF of the cover disk S. In this way, a holding plate 1 can for example be held on the components R and S already connected to one another using a screwed-in fastening bolt 3. The cover disk S is in the present invention axially pretensioned relative to the wheel disk R, to ensure a contact of both components R, S in the area of the disk head even under adverse components' tolerances. To that extent, in the present example not only the holding plates 1 are held on the flange RF using the fastening bolts 3, but also both flanges RF and SF are held together and an axial displacement of the flange SF of the cover disk S relative to the flange RF of the wheel disk R is prevented before its non-rotatable connection to the compressor shaft W is made at its flange WF. Only one recess or aperture is then provided for example at the flange WF of the compressor shaft W to receive the nut 31 screwed onto the fastening bolt 3. In the present case, all recesses or apertures formed in the flange WF of the compressor shaft W are identical, so that the number of positioning possibilities (in the circumferential direction) between both shaft parts (compressor and turbine) is not restricted.

Based on FIG. 8B, the structure of an additional balancing element 4 is also shown in more detail. An additional balancing element 4 of this type has a base 40 held in a positive connection using the head 30 of the fastening bolt 3 to the holding plate 1. Depending on the size and weight of the additional balancing element 4, the head 30 of the fastening bolt 3 can be partially or completely received in a sleeve section 41 of the additional balancing element 4. Alternatively, the balancing element can also have the shape of a ring washer, so that fixing of several balancing elements 4 on one fastening element is possible or at least simplified. The balancing elements are in the present invention standard balancing elements, so that overall only two additional customized heavier holding elements, i.e. adapted individually for the solution in accordance with the invention, for example, in the form of the holding plates 1.1 and 1.2 are required to permit balancing over a relatively wide range.

FIGS. 8C and 8D illustrate, supplementing FIGS. 8A and 8B, how using the respective fastening bolt 3 the associated holding plate, e.g. a holding plate 1.2 according to FIGS. 5A and 5B, is fixed to the flange RF of the wheel disk R, and the two flanges RF and SF of the wheel disk R and the cover disk S are connected to one another. FIG. 8C shows here the anti-score plates 22 provided for the nuts 21, each of which being assigned to four threaded bolts 2b, 2a and 2d, 2c of two adjacently positioned holding plates. One nut 31 each for a fastening bolt 3 is shown between two anti-score plates 22. The anti-score plates 22 provided on one side connect two threaded bolts 2b, 2a of a first holding plate and two threaded bolts 2d, 2c of a second holding plate, with the first and second holding plates being provided on an opposite side. The anti-score plates 22 provided on the one side are thus arranged in the circumferential direction in pairs and offset to the holding plates provided on the opposite side.

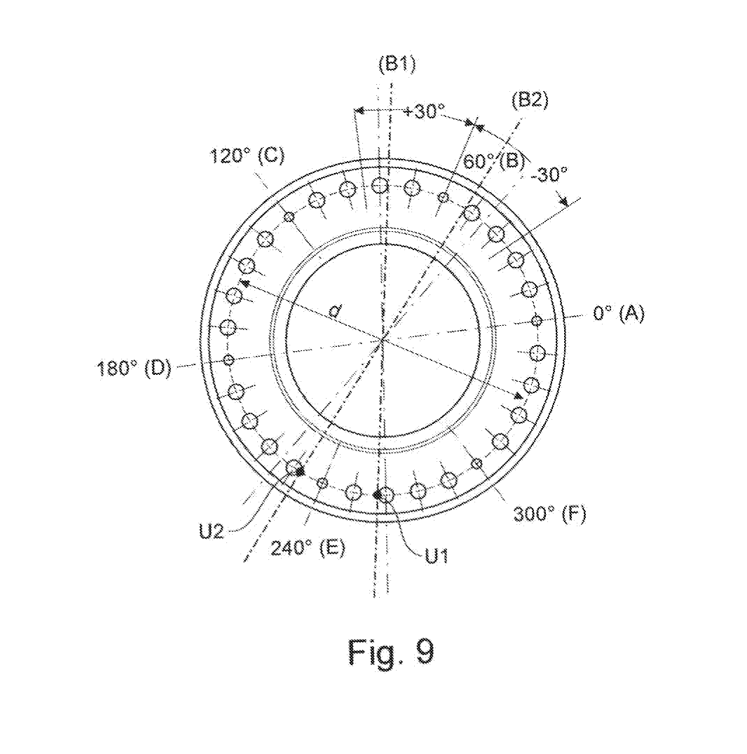

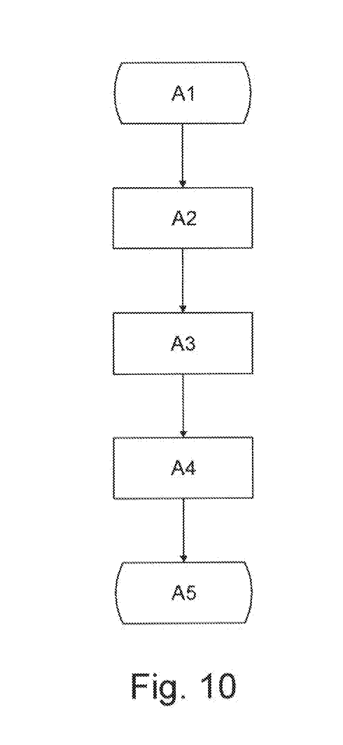

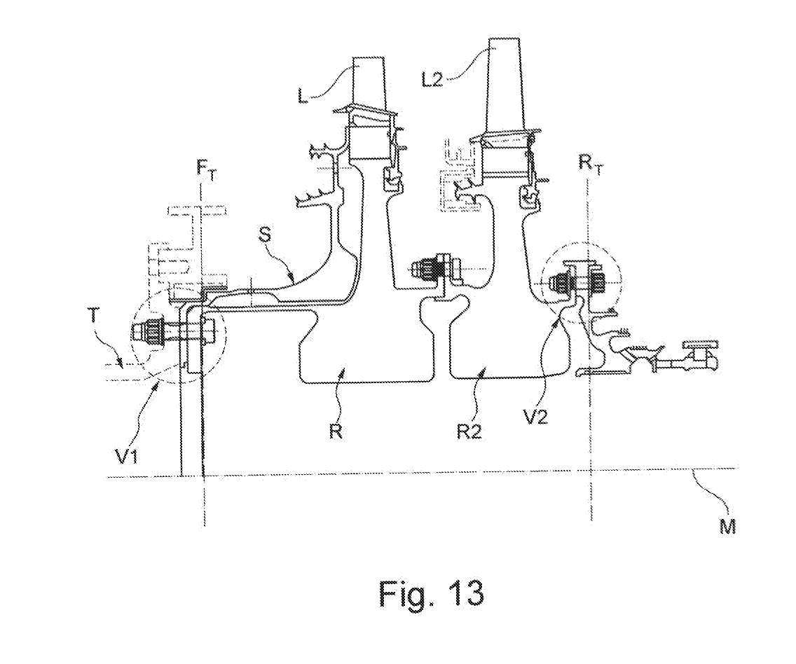

Based on FIGS. 9 and 10, the following is intended to illustrate the implementation of a balancing method on the basis of the solution in accordance with the invention. FIG. 9 here illustrates firstly the flange RF of the wheel disk R with the six fastening points provided equidistantly from one another on its circumference for the holding plates 1, 1.1 or 1.2. Accordingly, connection points (A) to (F) at 0°, 60°, 120°, 180°, 240° and 300° are shown here. As part of a possible balancing method in accordance with the invention, the holding plates 1 are fixed here using their fastening bolts 3 to the flanges RF and SF, so that the flanges RF and SF are thereby connected to one another. The fully assembled turbine shaft with the gas-turbine components S, R, R2, L, L2 and the bearing shaft, equipped with several (in this case six) identical holding plates 1 on the flange RF of the wheel disk R is then connected via at least twelve threaded bolts 2a to 2d to the compressor shaft W or—according to FIG. 13—to a fixture component T of a corresponding simulator and then mounted and set up on a balancing device in the form of a balancing machine. FIG. 13 shows here in a sectional view largely corresponding to FIG. 14 sections of a balancing device in which the turbine shaft can be connected to the fixture component T, which simulates a compressor shaft W. The balancing device is used in particular to measure whether an imbalance is present in the balancing plane F_{T} according to FIG. 13 or FIG. 14. The start of the balancing method in a step A1 as per FIG. 10 is accordingly followed firstly by the measurement of an imbalance in a step A2.

In a subsequent step A3, the balancing device indicates whether and where an imbalance is present. It is always the position in the circumferential direction {°} and the amount of imbalance {g*mm} that are measured. In this way the imbalance can also be shown as a vector. In FIG. 9, two possible imbalance points, U1 at 260° (calculated counterclockwise from connection point (A)) and U2 at 230°, are entered as examples.

Based on the ascertained imbalance in [g·mm] and the ascertained imbalance position a user can now compensate for the detected imbalance by suitable combination of two additionally provided further types of holding plates 1.1 and 1.2 and the provided set of additional balancing elements 4. In a possible design variant, an appropriate evaluation logic unit is already integrated into the balancing device to indicate directly to the user the number and positions of holding plates 1 to be replaced and/or the number, positions and/or weight of additional balancing elements 4 to be attached.

If for example at the imbalance point U1 an imbalance of 2450 g·mm is detected at 260°, the holding plates 1 at the connection points (B) and (C) must be replaced by holding plates 1.1 with a net extra weight (“net balancing weight”) of 12.5 g. Furthermore, an additional balancing element of 2 g must be provided at the connection point (A) and an additional balancing element of 0.5 g at the connection point (D) on the unchanged holding plates. Furthermore, an additional balancing element 4 with a weight of 6 g must be provided at the connection point (B) on the replaced holding plate 1.1:

TABLE 1

| | | | | | | | Total |
|---|---|---|---|---|---|---|---|
| | (A) | (B) | (C) | (D) | (E) | (F) | mass |
| Imbalance to be | 2 g | 12.5 g + | 12.5 g | 0.5 g | — | — | 33.5 g |
| compensated for | | 6 g | | | | | |
| 2450 g · mm at | | | | | | | |
| 260° | | | | | | | |

By fixing of a total of 33.5 g (net) of compensating mass at the positions (A) to (D), a correction vector is generated with the amount of 2450 g·mm at an angle of 80.5°, so that the measured initial imbalance can be corrected up to 20.7 g·mm (residual imbalance).

If at the imbalance point U2 an imbalance of 4700 g·mm is detected, it must be compensated for by replacing the holding plates 1 at the connection points (A) and (B) in particular by holding plates 1.2 of the third type with a net extra weight (“net balancing weight”) of 25 g, where these must each be provided with additional balancing elements of 0.5 g (connection point (A)) and 6 g (connection point (B)). Furthermore, a holding plate 1.1 of the second type with an extra weight of 12.5 g and an additional balancing element 4 of 3 g must be used at the connection point (C) instead of the (standard) holding plate 1. Furthermore, an additional balancing element 4 of 0.5 g must be arranged at the connection point (F):

TABLE 2

| | | | | | | | Total |
|---|---|---|---|---|---|---|---|
| | (A) | (B) | (C) | (D) | (E) | (F) | mass |
| Imbalance to be | 25 g + | 25 g + | 12.5 g + | — | — | 0.5 g | 72.5 g |
| compensated for | 0.5 g | 6 g | 3 g | | | | |
| 4700 g · mm at | | | | | | | |
| 230° | | | | | | | |

By fixing of a total of 72.5 g (net) of compensating mass at the positions (A), (B), (C) and (F), a correction vector is generated with the amount of 4685 g·mm at an angle of 49.9°, so that the measured initial imbalance can be corrected up to 16.3 g·mm (residual imbalance).

A position (B1), (B2) shown in FIG. 9 is in this example that position which is exactly opposite the respective imbalance U1 or U2. In other words, a position (B1) or (B2) is not fixed, but variable, i.e. depending on the angular position of the measured imbalance. The position (B) for attaching the compensating balancing mass has here the lowest angular offset to the respective position (B1) or (B2).

As the previously mentioned examples clearly show, a very precise compensation of imbalances can be made in the present variant with a comparatively low number of only six well-defined connection points for the three holding plates 1, 1.1 and 1.2 with different balancing weights and a small number (here: seven) of finely graduated additional balancing elements 4. After attachment of the corresponding additional balancing elements 4 and a possible replacement of holding plates 1 with heavier holding plates 1.1 or 1.2 in a process step A4, the balancing method then ends in a step A5 and the components thus equipped can be finally fixed.

The clamping lengths of the respective connecting elements—here in the form of threaded bolts 2a to 2d remain unchanged over the differing-weight holding plates 1, 1.1, 1.2, since the heavy holding plates 1.1 and 1.2 at the base 10 do always have the same thickness in that area at which the (bolt) apertures 14a, 14b, 15a, 15b are provided. Furthermore, all apertures 13 and 14a, 14b, 15a, 15b for the fastening and connecting elements 3 and 2a to 2d are on a pitch circle radius and have the same spacing. The result of this is that only one hole pattern on the compressor shaft W is required and both shaft parts can be positioned relative to one another depending on the number of these apertures.

By using the approach in accordance with the invention, an improved balancing quality compared with balancing methods previously used in actual practice can be achieved in a design variant with only six connection points (balancing positions) for three holding plate types even with a smaller number of differing-weight balancing weights. For example, three types of holding elements 1, 1.1 and 1.2 with a minimum weight difference of 15 g and three differing-weight types of additional balancing elements of 1.25 g, 2.5 g and 3.75 g fixable thereon can thus be provided for the six different connection points evenly distributed along the circumference. As the following tables 3a to 3d make clear here, a fine graduation in steps of 1.25 g each can already be achieved here despite the small number of predetermined balancing positions:

TABLE 3a

| | 0 g | 1.25 g | 2.5 g | 3.75 g | 5 g | 6.25 g | 7.5 g | 8.75 g | 10 g |
|---|---|---|---|---|---|---|---|---|---|
| 0° | 0 | 1.25 g | 2.5 g | 3.75 g | 3.75 g + | 3.75 g + | 3.75 g + | 15 g | 15 g |
| | | | | | 1.25 g | 2.5 g | 3.75 g | | |
| 180° | 0 | 0 | 0 | 0 | 0 | 0 | 0 | 3.75 g + | 2.5 g + |
| | | | | | | | | 2.5 g | 2.5 g |

TABLE 3b

| | 11.25 g | 12.5 g | 13.75 g | 15 g | 16.25 g | 17.5 g | 18.75 g | 20 g |
|---|---|---|---|---|---|---|---|---|
| 0° | 15 g | 15 g | 15 g | 15 g | 15 g + | 15 g + | 15 g + | 15 g + |
| | | | | | 1.25 g | 2.5 g | 3.75 g | 3.75 g + |
| | | | | | | | | 1.25 g |
| 180° | 3.75 g | 2.5 g | 1.25 | 0 | 0 | 0 | 0 | 0 |

TABLE 3c

| | 21.25 g | 22.5 g | 23.75 g | 25 g | 26.25 g | 27.5 g | 28.75 g | 30 g |
|---|---|---|---|---|---|---|---|---|
| 0° | 15 g + | 15 g + | 30 g | 30 g | 30 g | 30 g | 30 g | 30 g |
| | 3.75 g + | 3.75 g + | | | | | | |
| | 2.5 g | 3.75 g | | | | | | |
| 180° | 0 | 0 | 3.75 g + | 2.5 g + | 3.75 g | 2.5 g | 1.25 g | 0 |
| | | | 2.5 g | 2.5 g | | | | |

TABLE 3d

| | 31.25 g | 32.5 g | 33.75 g | 35 g | 36.25 g | 37.5 g |
|---|---|---|---|---|---|---|
| 0° | 30 g + | 30 g + | 30 g + | 30 g + | 30 g + | 30 g + |
| | 1.25 g | 2.5 g | 3.75 g | 3.75 g + | 3.75 g + | 3.75 g+ |
| | | | | 1.25 g | 2.5 g | 3.75 g |
| 180° | 0 | 0 | 0 | 0 | 0 | 0 |

If 12 balancing positions are provided, when using the approach in accordance with the invention, for example three differing-weight types of holding elements 1, 1.1 and 1.2 with a net extra weight each of 12.5 g and one type of additional balancing element 4 of 2.5 g are already sufficient to achieve an acceptable balancing quality:

TABLE 4a

| | 0 g | 2.5 g | 5 g | 7.5 g | 10 g | 12.5 g | 15 g |
|---|---|---|---|---|---|---|---|
| 0° | 0 | 2.5 g | 2.5 g + | 12.5 g | 12.5 g | 12.5 g | 12.5 g + |
| | | | 2.5 g | | | | 2.5 g |
| 180° | 0 | 0 | 0 | 2.5 g + | 2.5 g | 0 | 0 |
| | | | | 2.5 g | | | |

TABLE 4b

| | 17.5 g | 20 g | 22.5 g | 25 g | 27.5 g | 30 g |
|---|---|---|---|---|---|---|
| 0° | 12.5 g + | 25 g | 25 g | 25 g | 25 g + | 25 g + |
| | 2.5 g + | | | | 2.5 g | 2.5 g + |
| | 2.5 g | | | | | 2.5 g |
| 180° | 0 | 2.5 g + | 2.5 g | 0 | 0 | 0 |
| | | 2.5 g | | | | |

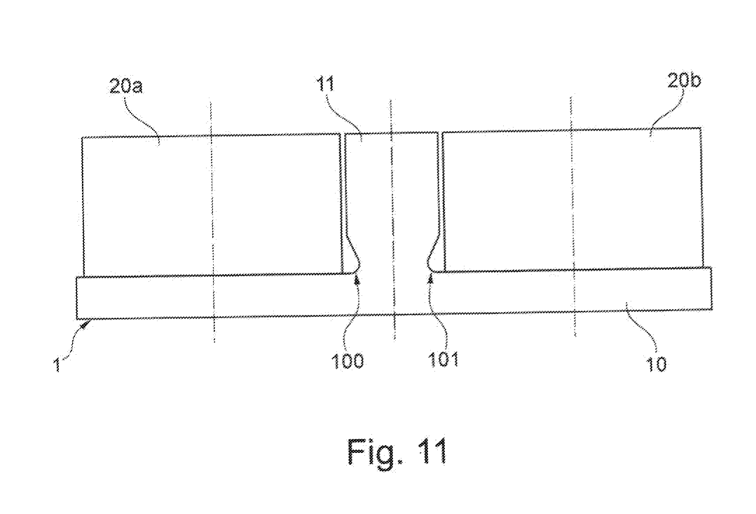

The sectional view in FIG. 11 shows in an enlarged scale the web 11 acting as a rotation preventer with two adjacent bolt heads 20a and 20b. Also shown here again are the indentations 100 and 101 on the lateral faces 110a and 110b at the root of the web 11 and facing away from one another.

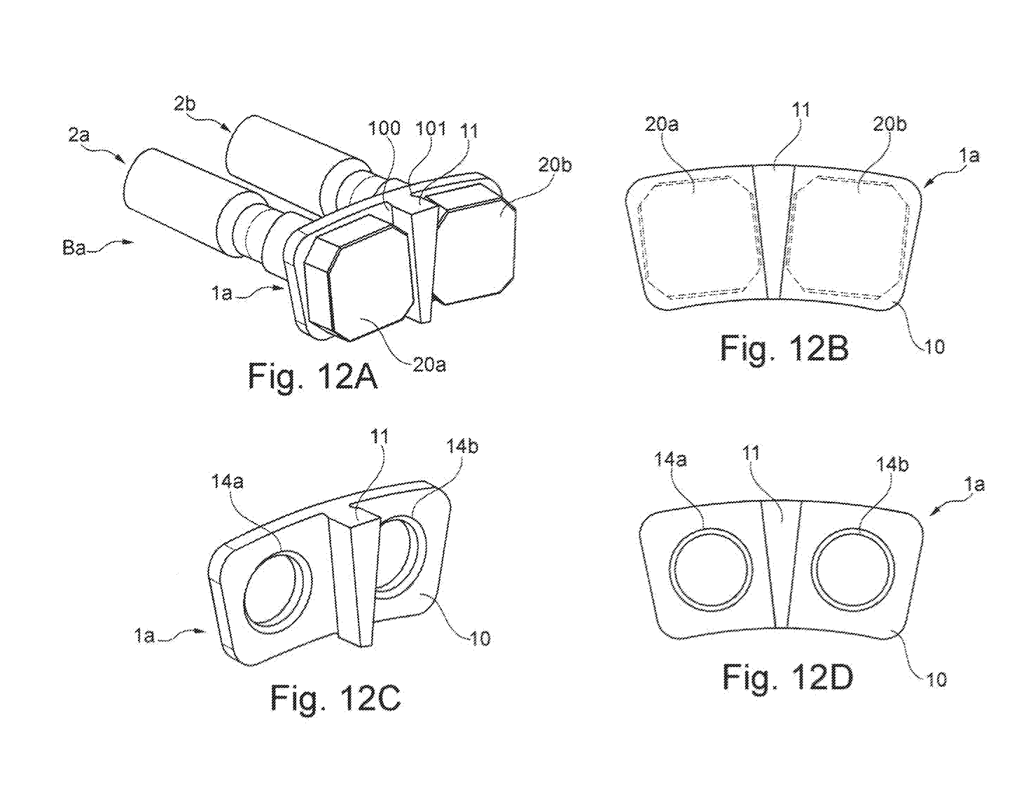

FIGS. 12A to 12D illustrate in different views a variant of a holding plate 1a for a fastening assembly Ba with only exactly one pair of threaded bolts 2a and 2b. In this variant, a comparatively short holding plate 1a defines only two bolt apertures 14a and 14b separated from one another by a single wedge-shaped and radially running web 11. At the root of this web 11 the indentations 100 and 101 are provided on both sides. In addition, the web 11 forms here a rotation preventer for the two threaded bolts 2a and 2b inserted into the bolt apertures 14a and 14b respectively.

Two fastening assemblies Ba of FIGS. 12A to 12D can if necessary be used alternatively to a fastening assembly B for four threaded bolts 2a to 2d in accordance with the previously explained design variants. Even if fastening assemblies Ba with only two bolt apertures 14a, 14b are used, differing-weight fastening assemblies Ba may be also provided for balancing using differing-weight holding plates and/or using additional balancing elements. Any additional balancing elements are here for example fitted underneath or on a bolt head of a threaded bolt 2a, 2b.

In all design variants shown, firmly mounted holding elements in the form of holding plates 1, 1.1, 1.2, 1a are provided and so in each case a balancing solution without additional holders, e.g. in the form of screws or clamps, is provided due to which balancing weights can be fastened to a shaft of a gas turbine.

In addition, it is of course not mandatory within the framework of the solution in accordance with the invention, to use a fastening assembly B or Ba designed in accordance with the invention for a turbine shaft. In divergence from the illustrated version, it can of course for example be provided in a design variant that an assembly designed in accordance with the invention is used on the compressor shaft W.

### LIST OF REFERENCE NUMERALS

1, 1.1, 1.2, 1a Holding plate (holding element)

10, 10.1, 10.2 Base

100, 101 Indentation

102 Extension

11 Web (rotation preventer)

110a, 110b Lateral face

12 Web (rotation preventer)

120c, 120d Lateral face

13 Fastening aperture

14a, 14b Bolt aperture

15a, 15b Bolt aperture

20a, 20b, 20c, 20d Bolt head

21 Nut

22 Anti-score plate

2a, 2b, 2c, 2d Threaded bolt (connecting element)

3 Fastening bolt (fastening element)

30 Head

31 Nut

4 (Additional) balancing element

40 Base

41 Sleeve section

b, b1 Width

B, Ba Fastening assembly

F_{T} Balancing plane

L, L2 Rotor blade

M Engine axis

R, R2 Wheel disk

RF Flange

R_{T} Balancing plane

S Cover disk

SF Flange

U1, U2 Imbalance point

T Fixture component/dummy

V1, V2 Connection area

W Compressor shaft (shaft component)

1. An assembly for the non-rotatable connection of at least two rotating components in a gas turbine, with the assembly including at least the following:
one holding element for at least four connecting elements intended for non-rotatable connection of the at least two components to one another, where the holding element
has for each of the connecting elements an aperture, into which a section of a connecting element (2a-2d) can be inserted, and
between two openings forms a section, which when the connecting elements are inserted into the apertures prevents them from rotating in the aperture,
and
at least one fastening element equipped and intended to hold the holding element on one of the components and/or to connect the holding element with at least two components of the assembly, before the at least two rotating components are non-rotatably connected to one another using the connecting elements,
wherein the fastening element is additionally equipped and intended to fix at least one balancing element on the holding element in order to compensate for an imbalance of the rotating components in the area of their connection, and a fastening aperture for the fastening element on the holding element is provided approximately in the middle between two pairs of apertures for the connecting elements.

2. The assembly in accordance with claim 1, wherein a balancing element fixed on the fastening element is positively fixed on the holding element by the fastening element.

3. The assembly in accordance with claim 1, wherein the section formed by the holding element for preventing rotation of the connecting elements is designed web-like and/or wedge-shaped.

4. The assembly in accordance with claim 3, wherein a longitudinally extending indentation is provided at the root of the section formed by the holding element on the base of the holding element.

5. An arrangement with at least two gas-turbine components which are non-rotatably connected to one another by at least one assembly in accordance with claim 1.

6. The arrangement in accordance with claim 5, wherein the at least two non-rotatably connected gas-turbine components rotate during operation of the gas turbine about a rotational axis, and at least two assemblies are arranged at a distance from one another along a circular line about the rotational axis, in order to connect the at least two gas-turbine components non-rotatably to one another.

7. The arrangement in accordance with claim 6, wherein less than twelve, in particular less than nine connection points are provided at which the at least two gas-turbine components connected to one another, each by means of an assembly.

8. The arrangement in accordance with claim 5, wherein the at least two gas-turbine components non-rotatably connected to one another rotate during operation of the gas turbine about a rotational axis, and the at least two gas-turbine components are non-rotatably connected to one another using at least two assemblies, where the holding elements have different weights, with the differing-weight holding elements having identical length, the heavier of the at least two holding elements however having in at least one section a greater thickness and/or width.

9. A method for balancing an arrangement in accordance with claim 5, with the following steps:
Providing at least two differing-weight first and second holding elements each with at least one fastening element,
Providing at least one balancing element that can be fixed using a fastening element on a first or second holding element
Connecting
(a) at least two gas-turbine components rotating during operation of the gas turbine, or
(b) one of the gas-turbine components rotating during operation of the gas turbine to a fixture component of a balancing device which simulates the at least one other gas-turbine component rotating during operation of the gas turbine
by means of several connecting elements extending through apertures on identically designed and identical-weight first holding elements,
Measuring of an imbalance in the connection area of the at least two gas-turbine components or in the connection area between gas-turbine component and fixture component, and
Replacing, in the case of a measured imbalance, at least one of the first holding elements by a second holding element with another weight and/or attaching at least one balancing element to one of the holding elements to compensate for the imbalance, where a set of at least two differing-weight types of balancing elements is provided, with their weights graduated in steps to one another, said elements being fixable on the holding elements using a fastening element in order to compensate for an imbalance.

10. The method in accordance with claim 9, wherein at least three differing-weight first, second and third holding elements each with at least one fastening element are provided.

11. The method in accordance with claim 10, wherein a weight difference between the weights of a second and a first holding element is identical to a weight difference between the weights of a third and second holding element.

12. The method in accordance with claim 9, wherein a minimum difference between two weights of differing-weight holding elements is not greater than double the maximum weight fixable on a holding element using at least one balancing element, plus the finest graduation in weight of two differing-weight types of balancing elements.

13. The method in accordance with claim 9, wherein a weight difference that can be provided by a balancing element fixable on a holding element or by several balancing elements fixable on the holding element corresponds to exactly, or to a maximum of half the minimum weight difference between two differing-weight holding elements.

14. The method in accordance with claim 13, wherein a set of balancing elements with at least three different weight stages is provided, where a weight difference between two balancing elements of directly consecutive weight stages is identical and corresponds to a maximum of one tenth of a minimum weight difference between two differing-weight holding elements.

15. The method in accordance with claim 9, wherein the measurement of an imbalance in the connection area of the at least two gas-turbine components or in the connection area between gas-turbine component and fixture component is performed by means of a balancing device displaying to a user the position, number and/or weight of balancing elements to be attached and/or the position and weight of holding elements to be attached in order to compensate for the measured imbalance.

16. A gas-turbine engine having an arrangement in accordance with claim 5.
